(19) United States
(12) Patent Application Publication
(10) Pub. No.: US 2010/0082434 A1
(43) Pub. Date: Apr. 1, 2010

(54) PERSONALIZED SEARCH RESULTS TO MULTIPLE PEOPLE

(75) Inventors: Jian Chen, Palo Alto, CA (US); Farzin Maghoul, Hayward, CA (US); Marc Davis, San Francisco, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/240,069

(22) Filed: Sep. 29, 2008

(51) Int. Cl. G06F 7/06; G06F 17/30; G06Q 30/00

(52) U.S. Cl. 705/14.55; 707/E17.108

(57) ABSTRACT

A method is disclosed for personalizing search results for delivery to multiple recipients, including receiving a search query by a search engine from a user on behalf of a group of users, wherein the group of users communicate through a plurality of communication devices at a plurality of locations; conducting a search of a database by the search engine to locate any data relevant to one or more terms of the search query; generating, by the search engine, a set of search results returned from the database according to at least one factor related to one or more of the group of users; and substantially simultaneously sending the set of search results to the plurality of communications devices of the group of users.

### BACKGROUND

1. Technical Field

The disclosed embodiments relate to generating search results for delivery to multiple people, and more particularly, to personalization of search results by a search engine for delivery to a group of recipients based on submission of a search query by one of the recipients.

2. Related Art

Consumers and business people increasingly use mobile phones or similar devices with which to communicate and to obtain information. These same people also look up information on the World Wide Web (“Web”) or Internet (via mobile device or personal computer) to find information regarding goods and services in commerce. Internet users sometimes, however, are unsure of what to look for or how to spell the name of a location or product of interest. Often, these same Internet users may participate in blogs or other social networking forums through which they obtain information relevant to a particular subject matter or relevant to the interests of various users of the blogs or other social networking forums. Access to search results of other users, however, is not usually available unless the user takes the time to post the search results on a blog or social networking forum. In these cases, the information quickly becomes stale and, over time, becomes no more than part of an informational discussion characteristic of blogs or social networking forums. Furthermore, in these cases, posted search results are not personalized to individual users or recipients that compose a group of users.

### SUMMARY

By way of introduction, the embodiments described below are drawn to generating search results for delivery to multiple people, and more particularly, to personalization of search results by a search engine for delivery to a group of recipients based on submission of a search query by one of the recipients.

In a first aspect, a computer-implemented method is disclosed for personalizing search results for delivery to multiple recipients, including receiving a search query by a search engine from a user on behalf of a group of users, wherein the group of users communicate through a plurality of communications devices at a plurality of locations; conducting a search of a database by the search engine to locate any data relevant to one or more terms of the search query; generating, by the search engine, a set of search results returned from the database according to at least one factor related to one or more of the group of users; and substantially simultaneously sending the set of search results to the plurality of communications devices of the group of users.

In a second aspect, a computer-implemented method is disclosed for personalizing search results for delivery to multiple recipients, including receiving a search query by a search engine from a user on behalf of a group of users, wherein the group of users communicate through a plurality of communications devices; searching a database by the search engine to locate any indexed documents or web pages relevant to one or more terms of the search query to be included in search results for delivery to the group of users; generating the search results for individual delivery to each of the group of users depending on any of a context of one or more terms of the search query and on a profile of each respective user; and substantially simultaneously delivering the search results to the plurality of communication devices of the group of users, wherein each user receives a customized version of the search results according to the profile of each respective user and to the context of the search query.

In a third aspect, a system is disclosed for personalizing search results for delivery to multiple recipients, including a search engine including a memory, a processor coupled with the memory, a communication interface coupled with the processor, and a database coupled with the processor, wherein the communication interface receives a search query from a user and the processor is operable to search the database to find search results relevant to one or more terms of the search query. A context detector is coupled with the processor and operable to detect a factor or profile related to any of a group of recipient users that use a plurality of communication devices and to detect a context of the search query. A multiple-people search results generator is coupled with the processor and operable to generate a set of search results from the database according to the context of the search query and to at least one factor or profile of each of at least some of the group of users. The communication interface sends, substantially simultaneously, the search results to the communication devices of each of the at least some of the group of users, wherein the search results sent to each corresponding user is customized according to the at least one factor or profile of each user.

In a fourth aspect, a mobile communication device of a user is disclosed for receiving personalized search results from a search engine, the mobile communication device including a processor coupled with a storage to store at least instructions, wherein the processor is operable to execute the instructions. A transmitter is coupled with the processor, the transmitter operable to transmit digital communications and a location of the mobile communication device to the search engine. A receiver is coupled with the processor, the receiver operable to receive search results returned by the search engine in response to a search query submitted to the search engine by another user in a group of users of which the user is a part, wherein the search results are made personal by the search engine in response to the submitted query based on one or more of the location and a profile of the user. A display is coupled with the processor and the storage, the display operable to display the personalized search results to the user along with the query that was submitted by the another user.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a diagram of an exemplary system for personalizing search results for a group of recipient users based on a user query of one of the group of users.

FIG. 2 is an exemplary mobile communications device capable of sending and receiving the search query and search results, respectively, as referred to in FIG. 1.

FIG. 3 is a flow chart of an exemplary method for personalizing search results for a group of recipient users based on a user query of one of the users.

FIG. 4 is a flow chart of another embodiment of a method for personalizing search results for a group of recipient users based on a user query of one of the users.

### DETAILED DESCRIPTION

By way of introduction, this disclosure is related to generating search results for delivery to multiple people, and more particularly, to personalization of search results by a search engine for delivery to a group of recipients based on submission of a search query by one of the recipients. Groups of people may have similar or contrasting interests, but may desire to be connected by receipt of personalized or customized search results when some member of a group conducts a particular search query. The system disclosed herein may be configured so that each of a group of users receives a personalized search result for every search query of one of the users in the group, or may be configured to include personalized search results only in certain circumstances or when only certain users submit the search results. In this way, some of the multiple recipients or users of the group may choose to only be recipients while others prefer to be both recipients and search query submitters.

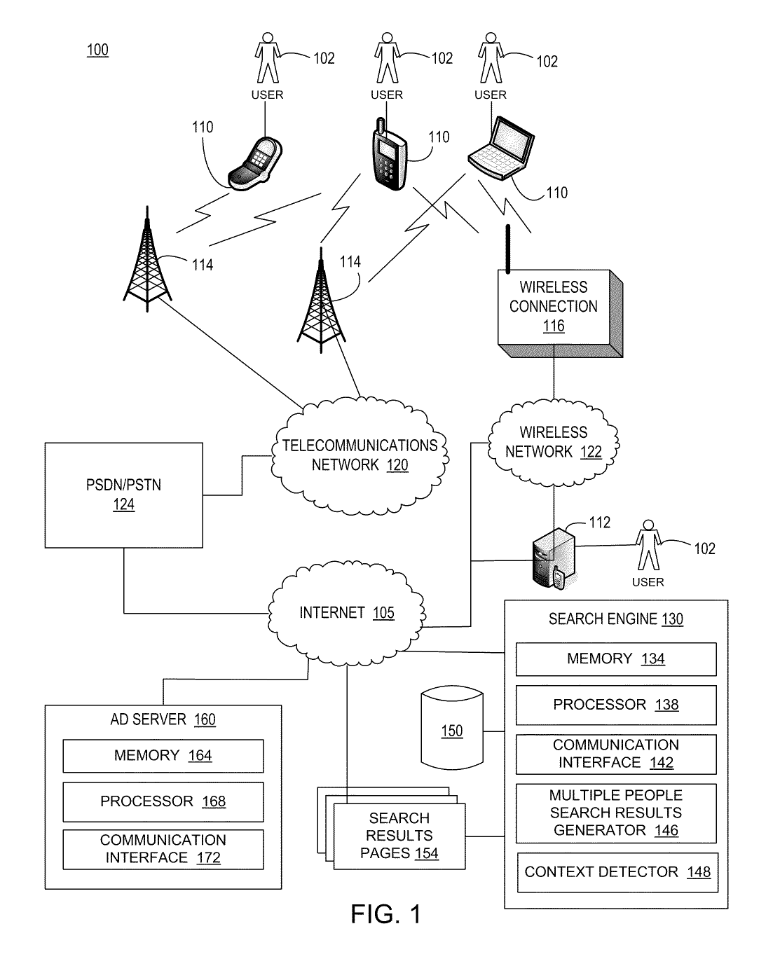

FIG. 1 is a diagram of an exemplary system 100 for personalizing or specifying search results for a group of recipient users 102 based on a user query of one of the group of users 102. The users 102 may communicate over and search through an Internet or World Wide Web (“Web”) 105 through any number of mobile communication devices 110 such cell phones, personal digital assistants (PDAs), a Blackberry™ by Research in Motion™, a laptop computer, a Bluetooth device, and any other mobile or semi-mobile device 110. The recipients 102 may also communicate over and search the Internet 105 through a personal computer 112 or other stationary communication device 112. The mobile devices 110 may wirelessly communicate with base transceiver stations 114, also referred to as cell sites or cellular towers. The system 100 may further include a wireless connection 116, such as a wireless hub, router, or the like.

The transceiver stations 114 may be coupled with a telecommunications network 120, which may include various pieces of switching hardware such as routers, switches, hubs, etc. Herein, the phrase “coupled with” is defined to mean directly connected to or indirectly connected through one or more intermediate components. The wireless connection 116 may be coupled with a wireless network 122, which may involve WiFi, Bluetooth, 802.11a, 802.11b, or the like technology for passing networked traffic, both voice and data. The system 100 may further include a Public Switched Data (and/or Telephone) Network (PSDN/PSTN) 124 through which the telecommunications network 120 may connect to the Internet 105. The Internet 105 may encompass other networks such as an intranet, a local area network (LAN), a wide area network (WAN), etc. The PSDN/PSTN 124 may include or be coupled with an Internet gateway (not shown) to facilitate access to the Internet 105. The mobile devices 110 may transfer and receive digital information or electronic data through the telecommunication network 120, through the wireless network 122, and over the Internet 105.

The system 100 may further include a search engine 130, including a memory 134, a processor 138, a communication interface 142, a multiple-people search results generator 146 (or search results generator 146), a context detector 148, a database 150, all of which may be coupled together and function to yield search results pages 154. The search results pages 154 may be sent over the Internet 105 and, where appropriate, over the telecommunications or wireless networks 120, 122 to the groups of recipient users 102 in response to a search query from one of the users 102. The search results pages 154 may be personalized to at least some of the users 102 and may be populated from documents, web pages, and other data relevant to terms of the search query. The system 100 may also include an ad server 160, including a memory 164, a processor 168, and a communication interface 172. The search engine 130 may include search capability extended to a peer-to-peer network or any distributed knowledge base.

The search results generator 146 may be configured to receive a search query from one of the group of users 102, and in conjunction with the context detector 148, determine different needs, contexts, or factors (variably referred to as a user profile) for each recipient user 102 that is to receive results from the search engine 130. The context, in some cases, will include detecting certain terms within the search query that trigger a connection with personalizing the search results for at least some of the group of users 102. Based on the user profile, the multiple-people search results generator 146 will personalize search results pages 154 relevant to the search query for delivery to a plurality of destinations, such as to web browsers (not shown) of the mobile communications devices 110 and/or to web browsers of the stationary communication devices 112. Delivery of the personalized search results to the mobile communication devices 110 or to the stationary communication devices 112 by the search engine 130 may occur substantially simultaneously.

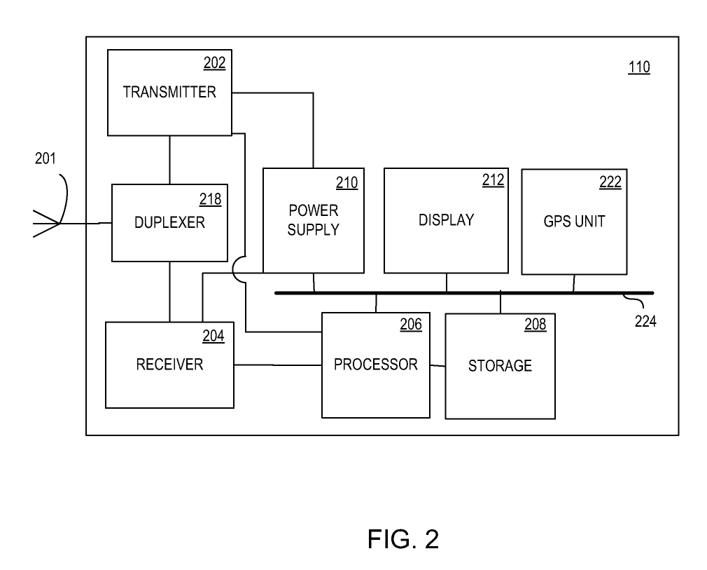

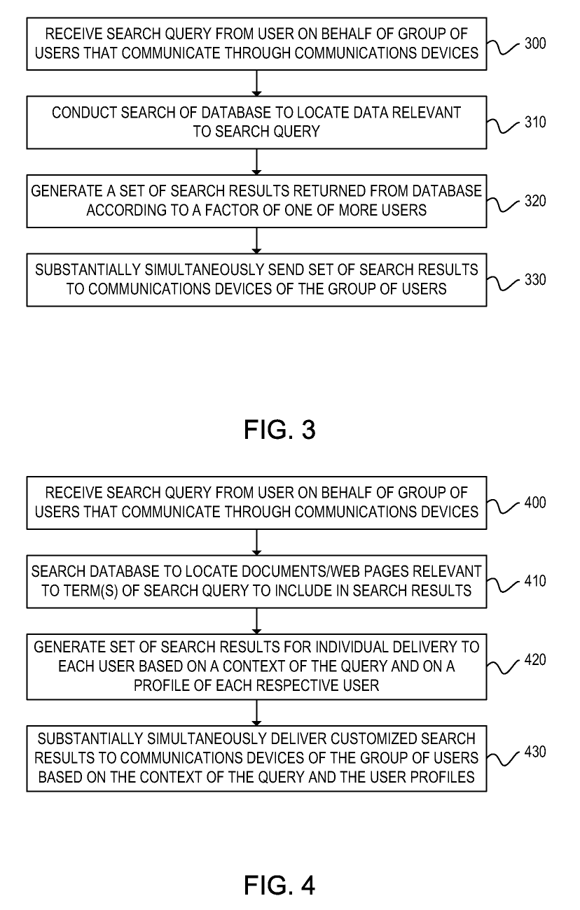

The search engine 130 may enable the group of users 102 to configure the search results generator 146 for their group by signing up for personalized search results services, and specifying parameters to be included within user profiles. The parameters may include, but are not limited to, specifying which of the group of users 102 may be search query submitters (if not all), and the types of interests that each of the multiple recipients 102 may have. Such interests may include, but are not limited to, subject matters of interest, of what sports teams, athletes, or celebrities that each of the multiple recipients 102 are a fan, politicians that each wants to follow, etc. The parameters may also include demographics of each of the multiple recipients 102, such as age, gender, race, ethnicity, and sexual preference. The context detector 148 may detect these parameters in submitted search queries as well as in settings detectable by virtue of the connection with the mobile or stationary communication device 110, 112. Such parameters include, for instance, a location detectable through a global positioning system (GPS) unit (222 of FIG. 2) or other location-tracking unit of the mobile communication devices 110, or through an internet protocol address of the stationary communication device 112. The parameters or factors referred to above may be included in the profile of each user 102, as appropriate. The profile of a sending user 102 may optionally include filtration parameters such as keywords or subject matter content that should filtered out of search results sent to a group of users 102 based on a submitted search query by the sending user 102.

The context detector 148 may then pass these parameters, factors, or settings of the user profile to the search results generator 146 to be used to personalized search results to at least some of the group of users 102. The search results generator 146 may personalize or customize the search results through selective filtration or through adjusting levels of relevance of terms within documents or web pages returned as results, which may lead to re-ranking a plurality of search results. Adjusting levels of relevance may be executed through attaching higher relevance values to resultant documents or web pages (or other data), followed by re-ranking of the plurality of search results. Sometimes no context, need, or factor will be detected, and therefore, no personalization may occur, but a normal set of search results may be returned in those cases. In search queries in which a demographic is detected as being related, the search results pages 154 delivered to each of the multiple recipients 102 may be filtered to remove subject matter of little interest or subject matter that may be offensive or inappropriate for that demographic. One non-exhaustive example includes filtering out adult-related or age-inappropriate content from search results sent to a young user 102, e.g., a teenager or younger. Accordingly, like with the filtration parameters set by a sending user 102, a recipient in a group of users 102 may create a filtration parameter within his or her profile that results in filtering out keywords or subject matter content of received search results from the sending user 102.

Furthermore, when personalized search results are sent to each user 102 in a group of users 102, the query (or search phrase) itself may be included. A number or all of the query terms, for instance, may be displayed with the search results. Each user 102 that submits a search query to the search engine 130 may also indicate whether or not the user 102 wants his or her identity to be displayed along with the query in the browsers of the recipient users 102. Similarly, each recipient user 102 may choose whether or not he or she wants the query or search phrase to be displayed, hidden from view, or simply eliminated from the browser. These preferences may also be incorporated with the profile of the user 102. If the search phrase is displayed, it may be in a search area of the browser of the user 102, which may allow the recipient user 102 to alter the search phrase in some way and resubmit the query to the search engine 130 to receive adjusted search results based on the resubmitted query. In this way, the recipient user 102 may also turn into a sending user 102 and the adjusted search results may be broadcasted substantially simultaneously to all the users 102 in the group of users 102.

The ad server 160 may be coupled with the search engine 130, either directly or over the Internet 105 or other network, to deliver advertisements relevant to the search query to the search results pages 154, which are to be delivered to individual users 102 together with the search results. The extent and size of such advertisements, or whether they are delivered at all, may be limited by the display size of the mobile communications devices 110 receiving the search results. The ad server 160 may communicate with the context detector 148 to receive information regarding needs, contexts, parameters/factors, or settings related to any of the multiple recipients 102. This information may then be employed to deliver advertisements relevant not only to the subject matter and context of the search query, but also to any other detectable factors or contexts that would help the ad server 160 to better target advertisements delivered to the browsers of the mobile or stationary communication devices 110, 112 of the group of users 102. A non-exhaustive example includes delivering an advertisement for a local restaurant or business to a mobile communications device 110 when the location of the mobile communications device 110 is detected to be within a local area.

FIG. 2 is an exemplary mobile communications device 110 capable of sending and receiving the search query and search results, respectively, as referred to in FIG. 1. The mobile device 110 includes an antenna 201, a transmitter 202, a receiver 204, a processor 206, a storage 208 (or memory 208), a power supply 210, a display 212, a duplexer 218, a global positioning system (GPS) unit 222, and a communications bus 224. The storage 208 may include software to run the mobile communications device 110, which is configured to send a search query and receive personalized search results from the search engine 130 over the Internet 105 or other network. As shown in this embodiment, the processor 206, the storage 208, the power supply 210, the display 212, and the GPS unit 222 are coupled to a communications bus 224. The communications bus 224 is operable to transmit control and communications signals from and between the components connected to the communications bus 224, such as power regulation, memory access instructions, GPS locations, and other system information. In alternative embodiments, the duplexer 218 directly couples the transmitter 202 and the receiver 204 to each other for faster two-way communications.

In this embodiment, the processor 206 is coupled to the receiver 204 and to the transmitter 202. One of ordinary skill in the art will appreciate that the processor 206 may include the GPS unit 222. Also, the antenna 201, the transmitter 202, and receiver 204 may be configured to send and receive voice and/or data through the local wireless connection 116, to include a Wi-Fi connection, etc. The GPS unit 222 (or other location-detection unit) may send GPS (or other) coordinate locations to the context detector 148 of the search engine 130. The communication interface 142 and context detector 148 may detect the location as a setting or context for use by the search results generator 146 to personalize the search results to be delivered to the display 212 of the mobile communications device 105. For instance, the geographic location of each mobile device 105 of each user 102 in a group of users 102 may be used as a context with which to personalize search results, wherein the search engine 130 returns search results that include providing directions to a geographic destination from the respective locations of at least some of the of users 102. This may be useful where the users 102 want to meet at an agreed-upon location such as a restaurant, but not everyone knows how to get to that location from where they are currently located. Furthermore, the context of the geographic location of each communication device 110, 112 may be used to generate search results that are filtered to include only those results relevant to a geographic area common to the locations of corresponding users 102 of the group of users 102.

In an embodiment, the search engine 130 sends results to a recipient user 102 such that personalized results of one or more other users 102 are also displayed in one or more different tabs of a web browser (not shown) of the communication device 110, 112 of the user 102. In this way, recipient users 102 may see what personalized search results look like, e.g., how they are ranked, for another user 102 of the group of users 102. In yet another embodiment, the browser of such a recipient user 102 is actively linked to the browser of the other user 102 so that the recipient user 102 may also track what documents of the search results of the other user 102 are accessed and/or read by the other user 102, and optionally other browsing activity by the other user 102. The ability of the user 102 to track the activities of the other user 102 on the personalized search results of the other user 102 may be curtailed by enabling the other user 102 so stipulate (or set) within his or her profile for privacy concerns.

FIG. 4 is a flow chart of an exemplary method for personalizing or specifying search results for a group of recipient users 102 based on a user query of one of the users 102. At block 300, the method includes receiving a search query by a search engine 130 from a user 102 on behalf of a group of users 102, wherein the group of users 102 communicate through a plurality of communication devices 110, 112 at a plurality of locations. At block 310, a search is conducted of a database 150 by the search engine 130 to locate any data relevant to one or more terms of the search query. At block 320, the search engine 130 generates a set of search results returned from the database 150 according to at least one factor related to one or more of the group of users 102. At block 330, the search engine 130 substantially simultaneously sends the set of search results to the plurality of communications devices 110, 112 of the group of users 102.

FIG. 5 is a flow chart of another embodiment of a method for personalizing or specifying search results for a group of recipient users 102 based on a user query of one of the users 102. At block 400, the method includes receiving a search query by a search engine 130 from a user 102 on behalf of a group of users 102, wherein the group of users 102 communicate through a plurality of communication devices 110, 112. At block 410, a database 150 is searched by the search engine 130 to locate any indexed documents or web pages relevant to one or more terms of the search query to be included in search results for delivery to the group of users 102. At block 420, the search engine 130 generates the search results for individual delivery to each of the group of users 102 depending on any of a context of one or more terms of the search query and a profile of each respective user 102. At block 430, the search engine 130 substantially simultaneously delivers the search results to the plurality of communication devices 110, 112 of the group of users 102, wherein each user 102 receives a customized version of the search results according to the profile of each respective user 102 and to the context of the search query.

In the foregoing description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine or computer-readable medium having stored thereon instructions that may be used to program a computer (or other electronic device) to perform processes described herein. The machine or computer-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A computer-implemented method for personalizing search results for delivery to multiple recipients, the method comprising:
receiving a search query by a search engine from a user on behalf of a group of users, wherein the group of users communicate through a plurality of communications devices at a plurality of locations;
conducting a search of a database by the search engine to locate any data relevant to one or more terms of the search query;
generating, by the search engine, a set of search results returned from the database according to at least one factor related to one or more of the group of users; and
substantially simultaneously sending the set of search results to the plurality of communications devices of the group of users.

2. The method of claim 1, wherein the communication devices comprise mobile communications devices.

3. The method of claim 1, wherein the at least one factor comprises a geographic location of each of the group of users, wherein the generating comprises making personal the set of search results by providing directions to a geographic destination from the respective locations of at least some of the plurality of users.

4. The method of claim 3, wherein the generating comprises filtering the search results to only those relevant to a geographic area common to the locations of at least some of the group of users.

5. The method of claim 1, further comprising:
sending, by the search engine, the search query to be displayed along with the search results in browsers of the plurality of communication devices of the group of users; and
enabling any of the group of users to alter and resubmit the search query to the search engine.

6. The method of claim 5, further comprising:
enabling the user that submitted the search query to allow or block display of an identity of the user along with the displayed search query.

7. The method of claim 1, wherein the search query is related to a sports game between at least two teams or athletes, and the at least one factor comprises of what team or athlete each of the group of users is a fan.

8. The method of claim 1, wherein the at least one factor comprises demographics, wherein generating comprises making personal the set of search results by filtering them according to a demographic of each user.

9. The method of claim 8, wherein the demographic comprises one or more of age, race, nationality, gender, or a combination thereof.

10. The method of claim 9, wherein filtering comprises removing predetermined mature topics from the set of search results for users below a specific age.

11. A computer-implemented method for personalizing search results for delivery to multiple recipients, the method comprising:
receiving a search query by a search engine from a user on behalf of a group of users, wherein the group of users communicate through a plurality of communications devices;
searching a database by the search engine to locate any indexed documents or web pages relevant to one or more terms of the search query to be included in search results for delivery to the group of users;
generating the search results for individual delivery to each of the group of users depending on any of a context of one or more terms of the search query and a profile of each respective user; and
substantially simultaneously delivering the search results to the plurality of communication devices of the group of users, wherein each user receives a customized version of the search results according to the profile of each respective user and to the context of the search query.

12. The method of claim 11, wherein the context comprises a geographic location of each user as determined by a location-tracking unit of each corresponding communication device, wherein the generating comprises filtering the search results to include only those relevant to a geographic area common to the locations of corresponding users.

13. The method of claim 11, wherein the context comprises a geographic location of each user as determined by a location-tracking unit of each corresponding communication device, wherein the generating comprises providing directions from a plurality of locations respectively associated with each user to another location related to the context of the one or more terms of the search query.

14. The method of claim 11, wherein the profile comprises demographics, wherein generating comprises customizing the search results by filtering them according to a demographic of at least some of the group of users, wherein the demographic comprises one or more of age, race, nationality, gender, or a combination thereof.

15. The method of claim 14, wherein filtering comprises removing predetermined mature topics from the set of search results for users below a specific age.

16. The method of claim 11, wherein the received parameter relates to interests of each of at least some of the group of users, the method further comprising:
detecting terms within the search query related to the profile of at least one of the group of users; and
making the search results personal to the at least one of the group of users by the search engine according to the profile upon detecting the related query terms, wherein the indexed documents or web pages located in the database that contain words having relevance to the detected query terms are given heightened relevance.

17. The method of claim 11, wherein the search engine enables the user that submits the search query and the users that receive the search query to set within their respective profiles that certain content or keywords be filtered out of the customized search results.

18. A system for personalizing search results for delivery to multiple recipients, the system comprising:
a search engine including a memory, a processor coupled with the memory, a communication interface coupled with the processor, and a database coupled with the processor, wherein the communication interface receives a search query from a user and the processor is operable to search the database to find search results relevant to one or more terms of the search query;
a context detector coupled with the processor and operable to detect a factor or profile related to any of a group of recipient users that use a plurality of communication devices and to detect a context of the search query; and
a multiple-people search results generator coupled with the processor and operable to generate a set of search results from the database according to the context of the search query and to at least one factor or profile of each of at least some of the group of users;
wherein the communication interface sends, substantially simultaneously, the search results to the communication devices of each of the at least some of the group of users, wherein the search results sent to each corresponding user is customized according to the at least one factor or profile of each user.

19. The system of claim 18, wherein the communication devices comprise mobile communication devices including global positioning system (GPS) units for determining a location of each mobile communication device,
wherein the context detector is operable to detect the location of at least some of the plurality of mobile communication devices from each corresponding GPS unit over a network.

20. The system of claim 19, wherein the search results generator makes personal the search results by providing directions to a geographic destination from the locations of the at least some of the plurality of mobile communication devices, wherein the geographic destination comprises a mutually-decided upon destination for the group of users to meet.

21. The system of claim 19, wherein the search results generator makes personal the search results by filtering the search results to include only results relevant to a geographic area common to the locations of the at least some of the plurality of mobile communication devices.

22. The system of claim 18, wherein the at least one factor or profile comprises demographics, wherein the search results generator makes personal the search results by filtering them according to a demographic of each of the group of users.

23. The system of claim 22, wherein filtering comprises removing predetermined mature topics from the set of search results for recipient users below a specific age.

24. The system of claim 18, wherein the factor relates to interests of each of at least some of the group of users;
wherein the context detector detects terms within the search query related to the factor or profile of at least one of the group of users; and
wherein the search results generator makes personal the search results according to the factor or profile upon detecting the related query terms by attaching higher relevance values to search results that contain words related to the detected query terms, and re-ranks the search results according to the new relevance values.

25. The system of claim 18, further comprising:
an ad server coupled with the search engine and operable to deliver advertisements to be sent with the search results to the communication devices, wherein the advertisements are related to the context of the search query or to at least one factor or profile of each of at least some of the group of users such that advertisements are personalized for each of at least some of the group of users.

26. A mobile communication device of a user for receiving personalized search results from a search engine, the mobile communication device comprising:
a processor coupled with a storage to store at least instructions, wherein the processor is operable to execute the instructions;
a transmitter coupled with the processor, the transmitter operable to transmit digital communications and a location of the mobile communication device to the search engine;
a receiver coupled with the processor, the receiver operable to receive search results returned by the search engine in response to a search query submitted to the search engine by another user in a group of users of which the user is a part, wherein the search results are made personal by the search engine in response to the submitted query based on one or more of the location and a profile of the user; and
a display coupled with the processor and the storage, the display operable to display the personalized search results to the user along with the query that was submitted by the another user.

27. The mobile communication device of claim 26, wherein the display includes a browser to display the search results, and wherein the processor enables the user to alter the search query and resubmit the search query to the search engine on behalf of the group of users.

28. The mobile communication device of claim 27, wherein the processor enables the user to hide or eliminate the display of the search query in the browser.

29. The mobile communications device of claim 27, wherein the processor enables the user to allow or block display of an identification of the user in a set of search results sent to each user in the group of users in response to the resubmitted query.

30. The mobile communications device of claim 27, wherein the receiver is adapted to receive personalized search results of another user of the group of users in a different tab of the browser, and is adapted to track a plurality of actions taken by the another user with respect to the personalized search results of the another user.
